(19) United States
(12) Patent Application Publication
(10) Pub. No.: US 2013/0146745 A1
(43) Pub. Date: Jun. 13, 2013

(54) MODULAR MANDREL FOR A MOLDING SYSTEM

(71) Applicants: Randy C. Foster, Strafford, MO (US); Randall R. Diefenderfer, Rogersville, MO (US); Michael M. Kamsickas, Bingham Farms, MI (US)

(72) Inventors: Randy C. Foster, Strafford, MO (US); Randall R. Diefenderfer, Rogersville, MO (US); Michael M. Kamsickas, Bingham Farms, MI (US)

(21) Appl. No.: 13/693,480

(22) Filed: Dec. 4, 2012

Related U.S. Application Data
(60) Provisional application No. 61/566,830, filed on Dec. 5, 2011.

(51) Int. Cl. B29C 33/76

(52) U.S. Cl. CPC B29C 33/76
USPC 249/176

(57) ABSTRACT

A mandrel for a molding system includes a support structure formed in a generally closed loop shape. The support structure is formed of a plurality of discrete segments coupled together. The number of discrete segments is increasable or reducible to change the overall geometry of the closed loop shape. The mandrel may be part of a molding system that includes a mandrel surface that closely fits about the outer surface of the mandrel body. The mandrel surface is formed of a plurality of discrete toothed segments that form a generally closed loop shape.

### RELATED APPLICATIONS

This application claims the benefit of U.S. provisional Application No. 61/566,830, filed Dec. 5, 2011.

### TECHNICAL FIELD

The present invention is directed to a molding system, and more particularly, to a modular mandrel component having a plurality of segments and a modular molding surface.

### BACKGROUND

In existing drive belt manufacturing operations, the belts and related components can be manufactured by pressing a material against outer and/or inner molding surface to form grooves and teeth on the belt material. Some existing belt molding surfaces are made of a rubber matrix or other similar material, which may be relatively inexpensive and easy to manufacture. However, such rubber molding surfaces typically provide less consistent shapes and inferior finishes to the drive belt or other components compared to metal-surfaced molding components, and may also lack durability, often lasting only a few production cycles. On the other hand, belt-molding components made of metal or other rigid materials are often expensive to manufacture, difficult to repair, and retain heat during the molding process.

The molding surface that the belt material is pressed against may be referred to as a mandrel. The mandrel is typically a cylindrical steel tube that may have an additional layer of polymeric material on the outside surface thereof for final sizing of the belt material. Since the mandrel is the foundation on which belts are formed, precise sizing and surface finish are important to producing high quality belts. Such mandrels are expensive and difficult to repair. Typically, a new mandrel is purchased rather than repaired.

Another problem with steel mandrels, with or without the polymeric material, is the amount of thermal energy stored and the rate of thermal conductivity. Heat is transferred to the mandrel during belt formation, which results in longer cure and cooling times before the belts can be removed therefrom.

### SUMMARY

Accordingly, in one embodiment, a modular mandrel is disclosed which can, in one embodiment, be made of a suitable metal or other relatively rigid material to provide an outer cylindrical surface upon which drive belt formation can occur. The mandrel includes a support structure formed in a generally closed loop shape that is formed from a plurality of discrete segments detachably coupled together and, optionally, a core centered within the support structure. The number of discrete segments forming the support structure is increasable or reducible to change the overall geometry of the closed loop shape, which may be generally cylindrical. The core may include outer surface features for maintaining the alignment of the plurality of discrete segments of the support structure.

Each discrete segment includes a first connector and a second connector for releasably interlocking each discrete segment to adjacent segments to the left and right thereof. The first and second connectors of each discrete segment may be the same or different. As labeled herein, the first connector of one segment is detachably coupled to the second connector of an adjacent discrete segment. In one embodiment, the first and second connectors on each discrete segment are different and the first connector includes a female portion and the second connector includes a male portion. The second connector also includes an overhang spaced radially outward away from the male portion such that a groove is defined therebetween. The female portion includes an inner rail and an outer rail. When the male and female portions are connected, the outer rail of the female portion is a tongue received in the groove of the second connector.

In another embodiment, the support structure has a generally circular shape in end view, and each discrete segment is generally wedge-shaped having at least one elongate passage therethrough. In one embodiment, the wedge-shaped segment is a truss having a plurality of elongate passages therethrough that supports a generally smooth outer edge.

In another embodiment, molding systems are disclosed that include a mandrel body having the modular support structure described above (and herein) and a mandrel surface formed from a plurality of discrete toothed segments that form a generally closed loop shape. The mandrel surface fits closely about the outer surface of the mandrel body with the teeth oriented radially outward away from the mandrel body. The molding system may also include a core centered within the support structure and a supplemental component formed in a generally closed loop shape and having a plurality of radially extending teeth that extend in the opposite direction to the teeth of the mandrel surface. Once assembled, the mandrel surface and the supplemental component are generally concentric and define a gap therebetween where a belt is formed during the molding process.

### BRIEF DESCRIPTION OF DRAWINGS

FIG. 1 is a front perspective view of one embodiment of a mandrel surface of the present invention;

FIG. 2 is a front perspective view of a mandrel segment of the mandrel surface of FIG. 1;

FIG. 3 is an end view of an alternate mandrel surface;

FIG. 4 is an end view of a mandrel segment of the mandrel surface of FIG. 3;

FIG. 5 is an end view of an alternate mandrel surface formed using the mandrel segment of FIG. 2;

FIG. 6 is a front perspective view of the mandrel surface of FIG. 1, shown being mounted on a mandrel body having a modular support structure;

FIG. 7 is an end view of the mandrel of FIG. 6, shown in conjunction with a curing sleeve with a belt positioned therebetween;

FIGS. 8A-8C illustrate a series of steps which may be utilized to form the curing sleeve of FIG. 7;

FIG. 9 illustrates an alternate method for forming the curing sleeve of FIG. 7;

FIG. 10 is an end view of one embodiment of a modular support structure of a mandrel body;

FIG. 11 is an end view of one segment of the modular support structure of FIG. 10;

FIGS. 12A and 12B are end views of alternate embodiments of discrete segments of a modular support structure similar to FIG. 10;

FIG. 13 is an end view of two discrete segments of a modular support structure connected by an independent connector;

FIGS. 14A-14C are perspective views of alternate embodiments of the independent connector connecting the support segments of FIG. 13;

FIG. 15 is an end view of support segments of one embodiment of a modular support structure;

FIG. 16 is a perspective view of one support segment of FIG. 15;

FIG. 17 is a perspective view of an end cap for aligning the support segments of FIG. 15; and

FIG. 18 is an end view of the mandrel having the support segments and end cap of FIGS. 15 and 17, shown in conjunction with a curing sleeve with a belt positioned therebetween;

### DETAILED DESCRIPTION

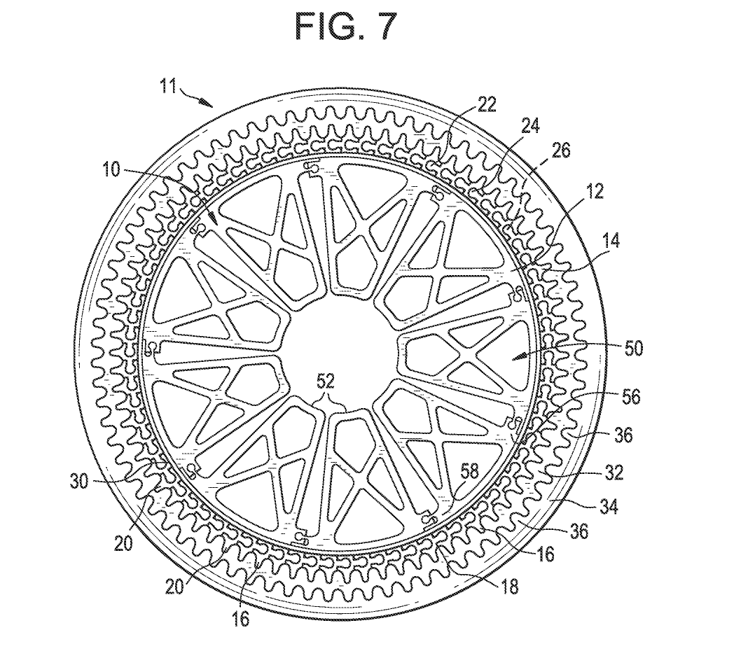

As shown in FIG. 7, in one embodiment the present invention takes the form of a molding system 11 in which a generally cylindrical belt 32, with inner and outer grooves thereon, is formed or molded. The belt 32 is positioned between a mandrel system or molding component 10, which forms the inner grooves of the belt 32, and a curing sleeve or jacket 34, which forms the outer grooves on the belt 32. The mandrel system 10 includes a generally cylindrical mandrel body 12 formed of a plurality of mandrel subsurface segments 52 and a generally cylindrical mandrel surface or component 14 formed in a generally closed looped shape and extending circumferentially around the mandrel body 12. The mandrel surface 14 has a plurality of radially-outwardly extending protrusions/teeth 16, and radially-inwardly extending recesses 18 positioned between each tooth 16.

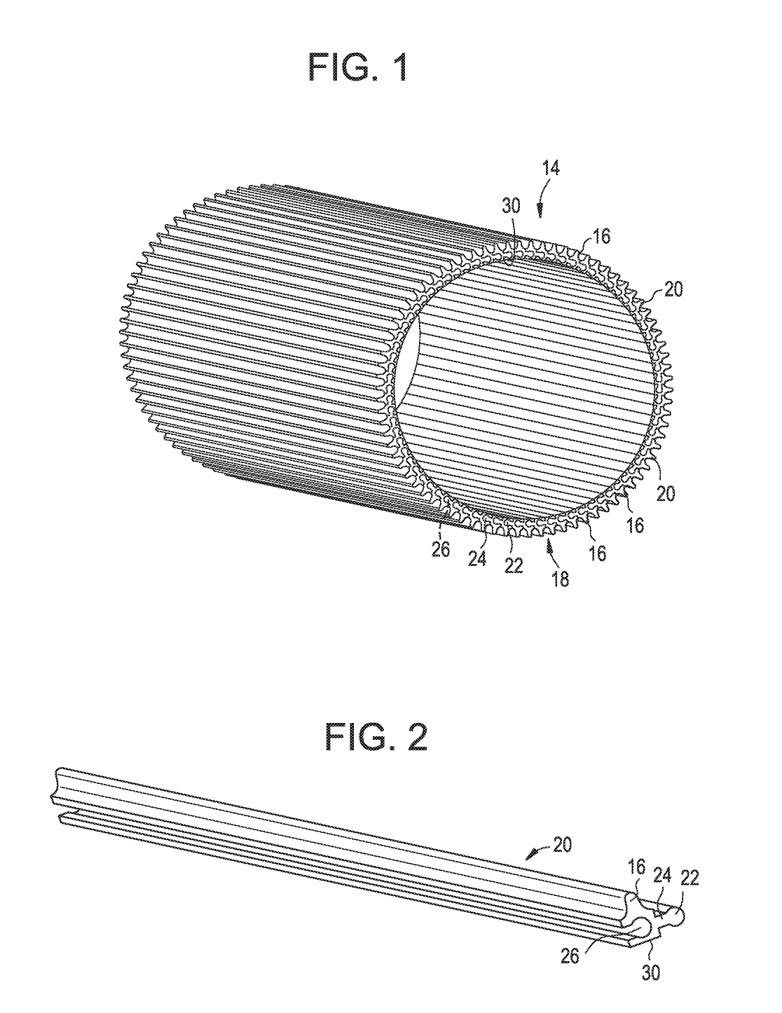

The mandrel surface 14 includes a plurality of mandrel segments 20 releasably interlocked together. In particular, in the embodiment shown in FIGS. 1 and 2, each mandrel segment 20 includes a locking portion 22 configured to releasably interlock to an adjacent mandrel segment 20. In the particular illustrated embodiment, each mandrel segment 20 has a male portion 24 and a corresponding opening or female portion 26, each shaped as generally circular or bulbous portions. Each male portion 24 of each mandrel segment 20 is receivable in a female portion 26 of the adjacent mandrel 20 segment to interlock the adjacent mandrel 20 segments together. The circular shape of the male 24 and female 26 portions allow the associated mandrel segments 20 to shift/pivot relative to each other, although the male 24 and female 26 portions can take any of a wide variety of other shapes and configurations besides circular.

In order to form the mandrel surface 14 from the mandrel segments 20, each male portion 24 is slid into a female portion 26 of an adjacent mandrel segment 20 in the axial direction until the mandrel segments 20 are generally axially aligned. Additional mandrel segments 20 are then mounted in the axial direction until a generally closed loop shape is formed, as shown in FIG. 1.

The mandrel surface 14 has a generally circular shape in end view, and each locking portion 22 (male portion 24/female portion 26) is positioned at or adjacent to a circumferential end surface thereof. This positioning ensures that the locking portions 22 do not interfere with the belt molding process, or attachment of the mandrel surface 14 to the mandrel body 12, as will be described in greater detail below.

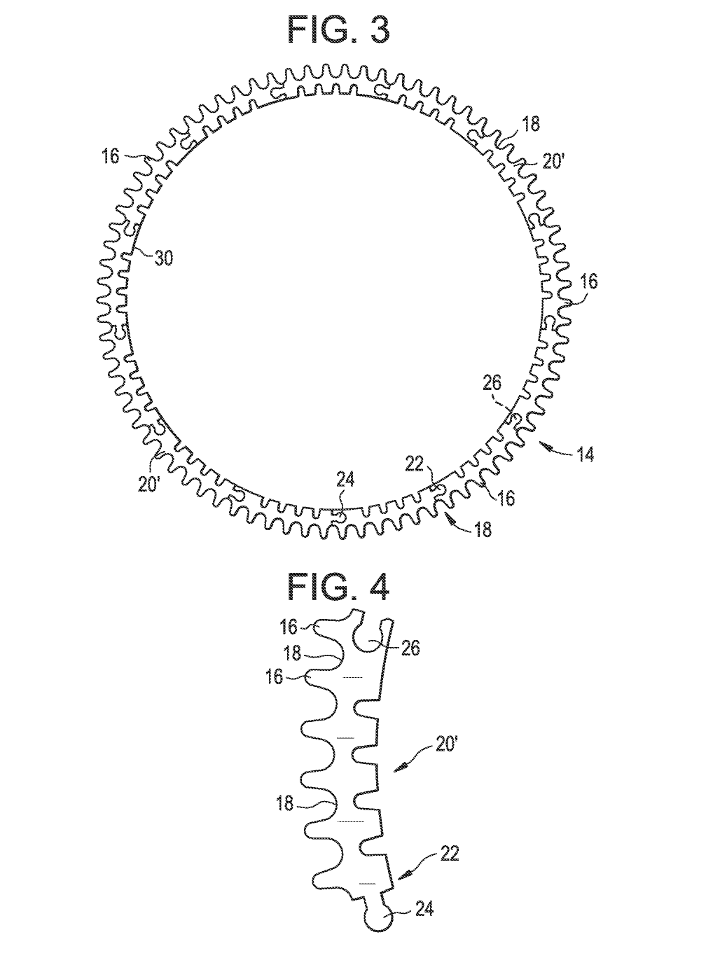

In the embodiments shown in FIGS. 1 and 2, each mandrel segment 20 has a relatively short circumferential length and includes a single radially outwardly-extending tooth 16. However, each mandrel segment 20 can include various other numbers of teeth 16 thereon. For example, in the embodiment shown in FIGS. 3 and 4, each mandrel segment 20′ has a longer circumferential length as compared to the embodiments of FIGS. 1 and 2 and includes six teeth 16 carried thereon. However, it should be understood that each mandrel segment 20, 20′ can include any of a variety of number of teeth 16 carried thereon. Moreover, in certain cases some mandrel segments 20 may be relatively short and may lack any teeth carried thereon. Such mandrel segments may act as a spacer or connector to connect teeth-bearing mandrel segments.

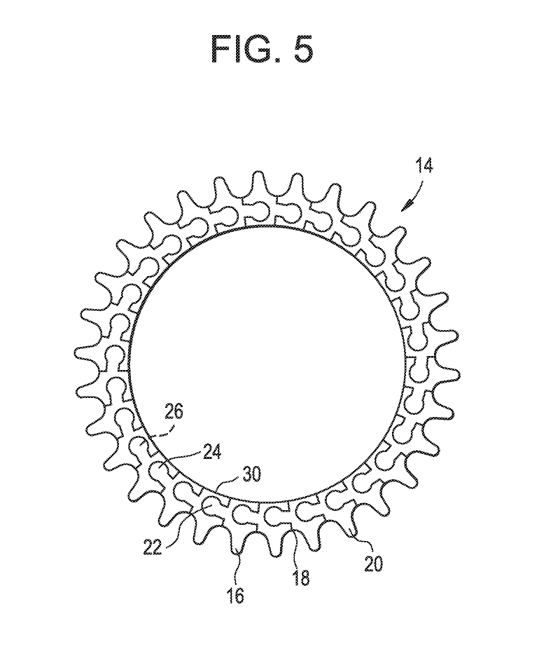

As can be seen, FIG. 1 illustrates a mandrel surface 14 made up of a relatively large number of mandrel segments 20 of FIG. 2. However, the number of mandrel segments 20 in a particular mandrel surface 14 can be varied as desired. For example, FIG. 5 illustrates an alternate embodiment in which a smaller number of mandrel segments 20 are utilized to form a mandrel surface 14 with a smaller radius compared to the mandrel surface 14 of FIG. 1. Thus, it can be seen that the modular nature of the mandrel segment 20 enables mandrel surfaces 14 of any of a wide variety of sizes to be assembled, having a radius ranging, in one case, from between about one inch to about six inches or more. The mandrel surface 14 may have a lower limit for its radius, given the fact that the radially inner edge 30 of the mandrel segments 20 may bind and interfere with each other. However, there is no impediment to adding additional mandrel segments 20 to form a larger mandrel surface 14, and in theory a mandrel surface 14 with as large a radius as desired can be formed. Thus, the mandrel surface 14 can be changed in diameter simply by adding/removing mandrel segments 20 as desired. In some cases, however, the mandrel surface 14 may be permanently formed by coupling the mandrel segments 20 together, such as by welding, attachment brackets, or by other metallurgical, mechanical, or other attachment methods.

The radially inner edge 30 of each mandrel segment 20, in one embodiment, has a radius of curvature. In some cases, then, the mandrel surface 14 may have an effective inner radius that is the same as the radius of curvature of the inner edges 30 such that each inner edge 30 smoothly transitions to an adjacent inner edge 30. However, as should be clear from the discussion above, the mandrel surface 14 can have an effective inner radius that differs from the radius of curvature of the associated mandrel segments 20 such that the inner edges 30 form more of a polygon shape.

In the illustrated embodiments, each mandrel surface 14 is made of a plurality of mandrel segments 20 that are substantially identical in size and shape. However, if desired, differing sizes and/or shapes of mandrel segments 20, including mixing and matching the mandrel segments 20, 20′ shown in FIGS. 2 and 4, or others, can be utilized to form a mandrel surface 14.

As can be seen, each mandrel segment 20 can be made of an extruded piece of material such as metal, more particularly aluminum, aluminum alloys or the like, or other suitably hard and durable material. In addition, when the mandrel surface 14 is assembled, the mandrel surface 14 may be generally cylindrical and have an axial length that is at least about as long as the radius of the cylinder, or at least about one quarter of the radius of the cylinder, to provide a relatively elongated cylinder appropriate for forming conventional drive belts.

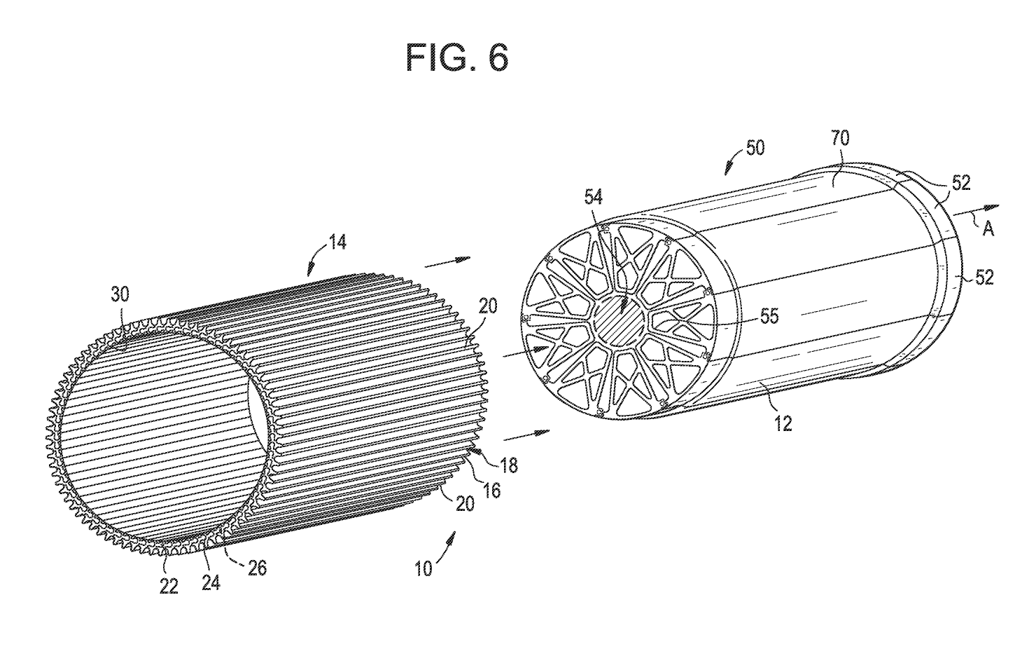

After the mandrel surface 14 of the desired shape and characteristics is formed, the mandrel surface 14 may be coupled to the mandrel body 12, as shown in FIG. 6. The mandrel surface 14 can be coupled to the mandrel body 12 by any of a wide variety of mechanisms or means, such as welding, adhesives, mechanical attachments, the use of locking rings, retaining rings, interlocking attachments, etc. The mandrel body 12 is generally cylindrical in the illustrated embodiment, and closely receives the mandrel surface 14 thereon such that the radially inner surface of the mandrel surface 14 is closely received over, and supported by, the mandrel body 12. In the illustrated embodiment of FIG. 6, the mandrel body 12 is shown as a modular support structure 50 having a plurality of discrete support segments 52 optionally supported by a core 54.

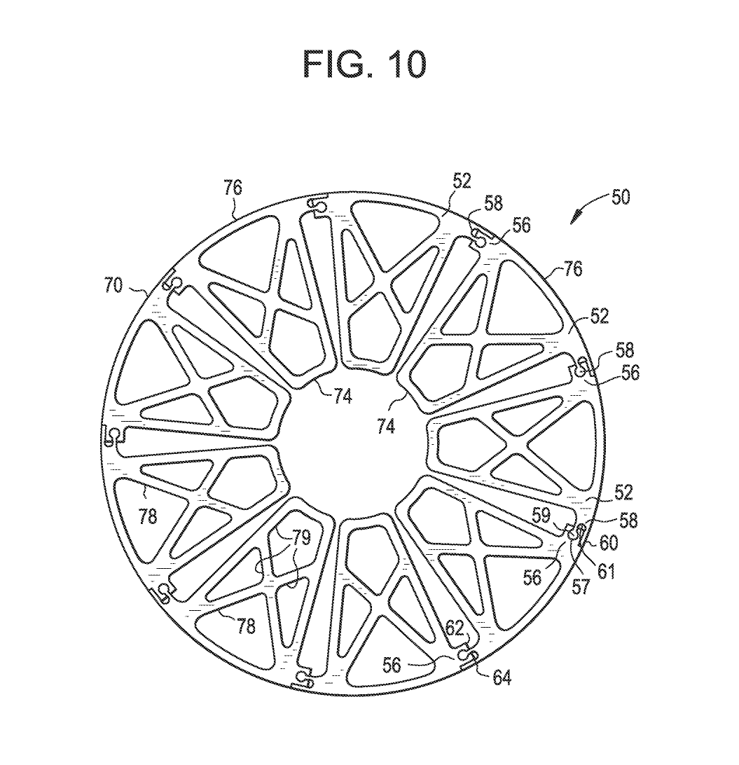

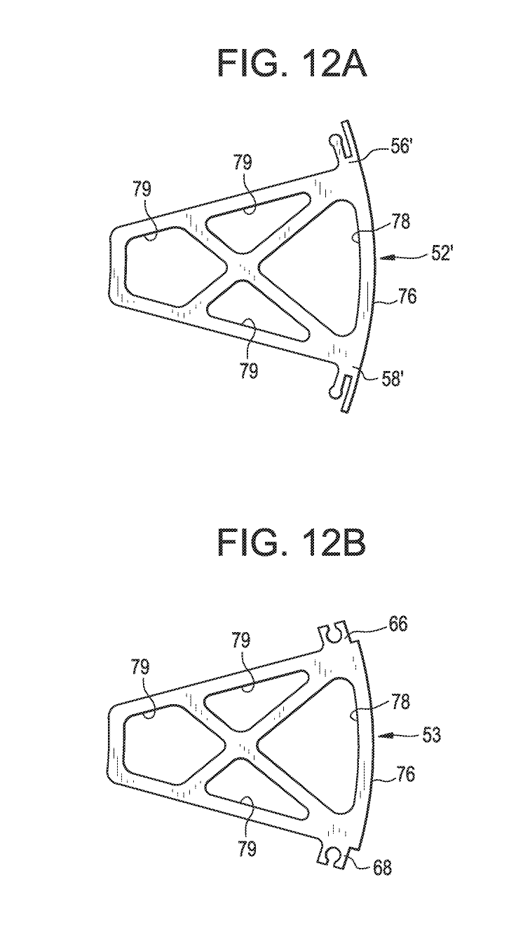

The mandrel body 12 as shown in FIG. 7 is formed of a plurality of discrete support segments 52 that may be permanently connected or releasably connected to one another. In one embodiment, each discrete support segment 52 has generally the same size and shape as all other discrete support segments 52 used to form the support structure 50. In another embodiment, alternating or periodic discrete support segments 52 may have differing sizes and/or shapes. Regardless of the size and shape, each discrete support segment 52 includes a first connector 56 and a second connector 58. In the illustrated embodiment of FIGS. 7 and 10, the first connector 56 and the second connector 58 are different on each discrete segment 52. The segments 52 are not limited thereto, and as shown in FIGS. 12A and 12B the first connector 56′ and the second connector 58′ on a first discrete segment 52′ may be the same, and the first connector 66 and second connector 68 on a second discrete segment 53 may be the same, but yet be different from the connectors 56′, 58′. This type of modular mandrel body 12 allows the number of discrete support segments 52 or 52′, 53 to be increasable or decreaseable to change the overall geometry of the closed loop shape defined by the outer surface 70 of the discrete support segments 52.

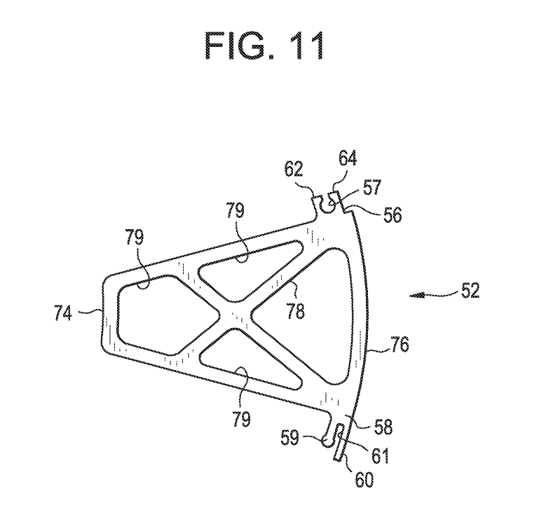

Referring to FIGS. 10 and 11, the first connector 56 includes a female portion 57 and the second connector 58 includes a male portion 59, both of which are generally circular or bulbous portions that are mateable to one another. Each male portion 58 of each support segment 52 is receivable in the female portion 56 of the adjacent support segment 52 to connect the adjacent support segments together. The second connector 58 also includes an overhang 60 spaced radially outward away from the male portion 59 such that a groove 61 is defined therebetween. The female portion 57 is defined by an inner rail 62 and an outer rail 64. When assembled, the outer rail 64 is a tongue received in the groove 61 defined by the second connector 58. This additional interconnection of adjacent support segments 52 adds rigidity to the support structure 50. The circular or bulbous shape of the male and female portions 56, 58 allow the associated mandrel segments 20 to shift/pivot relative to each other, but only to the extent allowed by the overhang 60. While the male and female portions 56, 58 are illustrated as circular, they can take any of a wide variety of other shapes and configurations.

The support structure 50 has a generally circular shape in end view. As best seen in FIG. 10, each discrete support segment 52 is generally wedge-shaped with a radially inner edge 74 that has a radius of curvature and a radially outer edge 76 that has a radius of curvature. The outer edge 76 of each discrete support segment 52 forms an arc of the circumference of the outer surface 70 of the mandrel body 12 when assembled. The arc terminates at its first end with the first connecter 56 and at its second end with the second connector 58. The first and second connectors 56, 58 are positioned at or adjacent to the outer edge 76, which ensures that the connectors do not interfere with the belt molding process, or attachment of the mandrel surface 14 to the support structure 50. The arc of each discrete segment may be any choice of division of 360 degrees to form up to about 120° of the circumference of the outer surface 70.

The generally wedge-shaped support segments 52 include at least one elongate passage 78 (FIGS. 10-12) extending generally parallel to the central longitudinal axis A of the mandrel body 12 (FIG. 6). In one embodiment, the generally wedge-shaped support segments 52 include a plurality of elongate passages extending generally parallel to the central longitudinal axis A. When a plurality of elongate passages is present, the support segments 52 may be described as a truss having an arc as its outer edge 76. The presence of one or more of these elongate passages 78, 79 improves heat transfer during the heating and cooling cycles during the molding process, such as those experienced when molding power transmission belts and results in shorter processing times, which saves time and money. The elongate passages 78, 79 also provide for more uniform curing of the molded product.

Interestingly, as shown in FIG. 10, when adjacent support segments 52, 52 are connected at their respective outer edges 76, their respective inner edges are held apart from one another thereby creating a gap. This gap may receive a surface feature 55 from the core 54 (FIG. 6) such as a spline on its outer surface. In one embodiment, the core 54 may be permanently coupled to one discrete support segment 52. In another embodiment, the core may be removeably couplable to the plurality of support segments 52 and may be added and/or removed during the molding production steps as needed. In some cases, the support segments 52 may be permanently coupled together, such as by welding, attachment brackets, or by other metallurgical, mechanical, or other attachment methods.

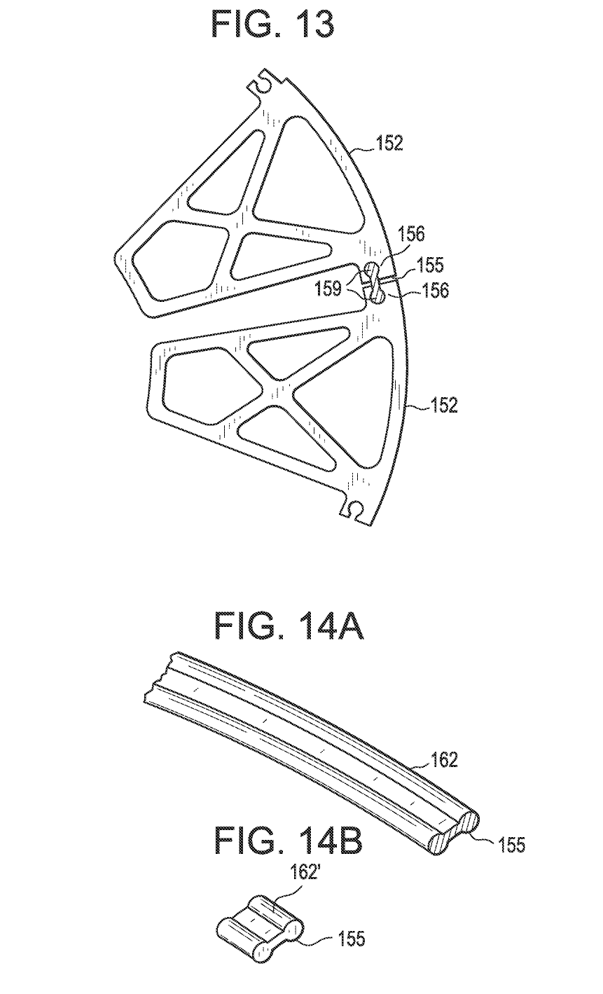

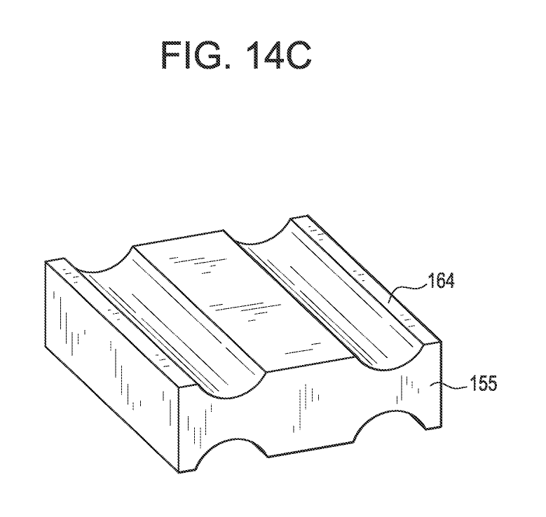

In the alternate embodiment of FIG. 13, the discrete support segments 152 may be connectable to one another through an independent connector 155. As illustrated in FIGS. 14A-14C, the independent connector 155 may be a generally dog-bone shaped connector 162, 162′, 164 that has two male ends 159. The male ends 159 are connectable, permanently or releasably, to female portions 156 of the discrete support segments 152. Permanently couplable includes but is not limited to attachments that are brazed, welded, or adhered. It is equally possible that the independent connector may contain two female ends and the discrete support segments include male portions that are connectable thereto. In another embodiment, the independent connector may include one male and one female portion for connecting to adjacent discrete support segments.

In one embodiment, the dog-bone shaped connector 162 (FIG. 14A) is generally as long as the discrete support segments 152. In another embodiment, the dog-bone shaped connector 162′ (FIG. 14B) is a generally short connecting strip. The connector 162′ may be about 0.5 inches long to about 6 inches long. The dog-bone connectors 162, 162′ are illustrated as having generally rounded lobed ends. On the contrary, the dog-bone connector 164 of FIG. 14C has generally squared-off ends. Dog-bone connectors 162, 162′, and 164 are not intended to be limiting as to the shape of the independent connector 155, but are merely examples.

In one embodiment, to form the mandrel body 12, a core 54 (FIG. 6) is provided to align the discrete support segments 52 and each support segment 52 is slid interlocked to its neighbor by sliding the first and second connector 56, 58 together to define a generally smooth other surface 70. The second connector 58 may be slid into the first connector 56 of an adjacent support segment 52 in the axial direction until the support segments 52 are generally axially aligned. Additional support segments 52 are then mounted in a like manner in the axial direction until a generally closed loop shape is formed, as shown in FIGS. 6 and 10.

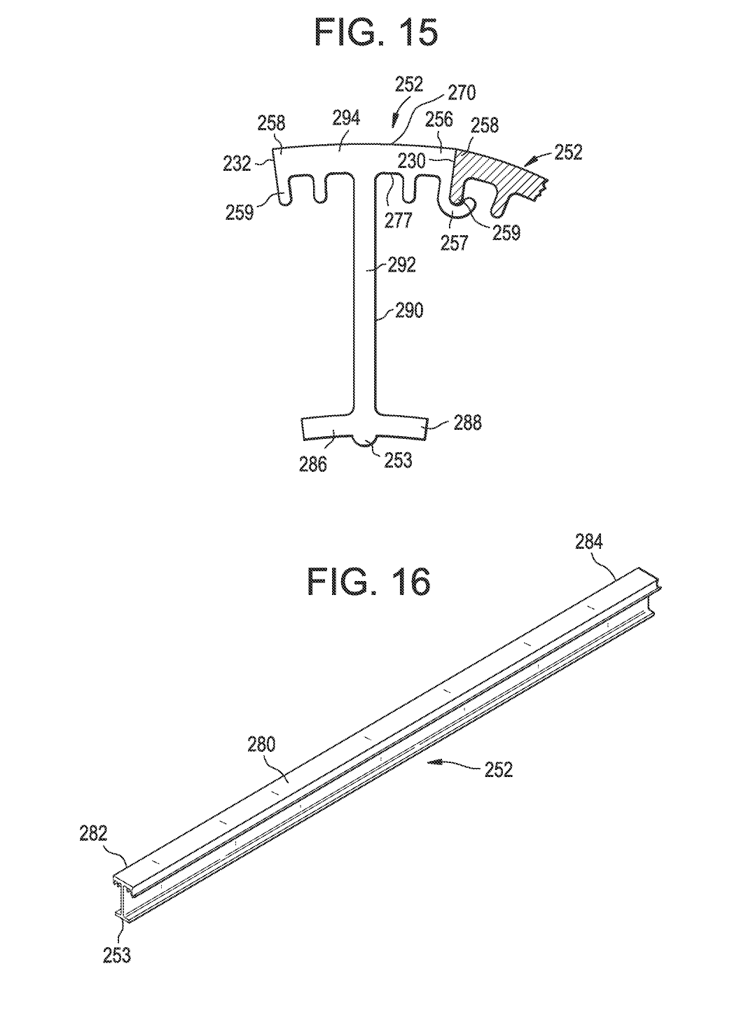

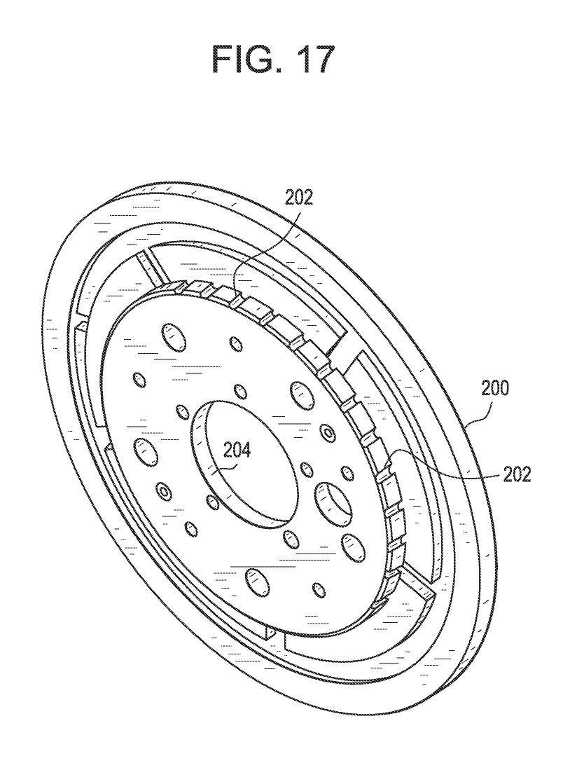

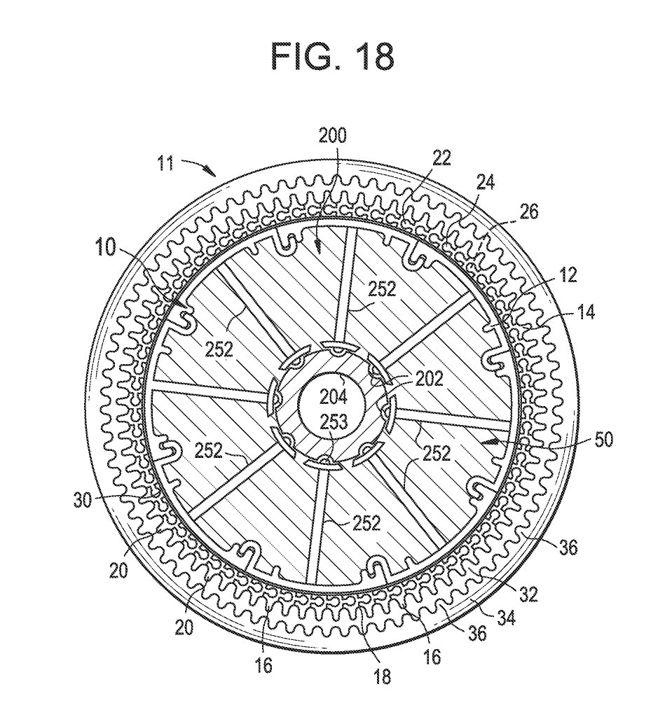

Referring now to FIGS. 15-17, the mandrel body 12 may be formed using an end plate or cap 200 (FIGS. 17 and 18), in addition to a core or as an alternative to the core 54 (FIG. 16), to align (and maintain the alignment of) the discrete support segments, in particular, key-containing support segments 252 (FIG. 15) that key into a receptacle 202 of the end cap 200. Even though the key-containing support segments 252 are illustrated in FIG. 15 as having generally T-shaped bodies 290, any of the aforementioned discrete support segments 52, 152 having a wedged, trussed, or other shaped body may include a key 253 for connection to an end cap. The end plate or cap 200 (FIG. 17) is typically centered at the terminus of the discrete support segments 252 to form the segments into a closed loop structure that can support the mandrel surface 14 and the other components of the molding system 11. The mandrel body 12 (FIG. 18) preferably includes two end caps 200 at opposite terminus ends 282, 284 (FIG. 16) of the discrete support segments 252. The end caps 200 are typically both directed, biased, or held with inwardly directed forces, directed generally toward the opposite end cap. The end caps 200 may include a bore 204 for receiving a rod, bolt, or spring for applying the inwardly directed forces or may receive an alignment pin portion of a clamping mechanism that applies the inwardly directed forces.

In the embodiment of FIGS. 15, 16 and 18 the key 253 is generally a rib running the length of the key-containing support segment 252. The rib is illustrated as positioned on the bottom surface 286 of the base 288 of the generally T-shaped body 190 of the key-containing support segment 252. The key 253 is not limited to being positioned on the bottom surface 286 and may be positioned on any of or even more than one surface of the key-containing support segments 252. Conversely, the end cap 200 may include a plurality of keys and each discrete support segment 252 may include a receptacle.

The key-containing support segments 252 of FIG. 15 have less complex attachment means 256, 258 since they are keyable to the end cap 200. Each key-containing support segment 252 has a generally T-beam shaped body 290 that includes a base 288, a center arm 292, and an arched top 294. The arched top 294 terminates at a first end 230 with a first connecter 256 and at a second end 232 with a second connector 258. The first and second connectors 256, 258 are positioned at or adjacent to the inner edge 277, which ensures that the connectors do not interfere with the belt molding process, or attachment of the mandrel surface 14 (FIG. 6) to the support structure 50. The arc of each discrete segment may be any choice of division of 360 degrees to form up to about 120° of the circumference of the outer surface 270. Still referring to FIG. 15, the first connector 256 includes a generally straight flange 259 projecting inward toward the central longitudinal axis A when the segments 252 are assembled, and the second connector 258 includes a generally J-shaped flange 257, when viewed in cross-section, that also projects inward toward the central longitudinal axis A when the segments 252 are assembled. Furthermore, when assembled the generally straight flange 259 of a first key-containing support segment 252 seats in the generally J-shaped flange 257 of the adjacent key-containing support segment 252 such that outer surfaces 270 of both segments are aligned.

The end plate 200 (FIG. 17) may have a large enough diameter that the mandrel surface 14 also terminates against the end plate(s) 200.

The mandrel body 12, when assembled, may be any desired length for the manufacturing process of the belt to be formed. Similarly, the mandrel may have any practical outer dimension for the belt to be formed, such as a diameter (if the outer surface is round). In one embodiment, the belt to be formed may have a radius of three inches up to about 24 inches.

Each discrete support segment 52, 152, 162, 252 and/or independent connector 155 may be an extruded piece of material such as metal, more particularly aluminum, aluminum alloys or the like, or other suitably hard and durable material. Extrusion pieces provide for ease of manufacture and reproducibility for a cost effective product. If desired, differing sizes and/or shapes of support segments 52, based on the final drum size desired, can be extruded and utilized to form the support structure 50.

Once the mandrel body 12 comprising the support structure 50 and core 54 or support structure 50 and end cap(s) 200 and the mandrel surface 14 are assembled into a unit as shown in FIG. 7 or FIG. 18, the mandrel system 10 can be used to form drive belts such as power transmission belts. In particular, the belt can be formed by placing a material 32, such as rubber, rubber plies, built-up rubber plies or the like, about the mandrel surface 14. A curing sleeve 34, such as a suitable sleeve, jacket or the like, is then placed around the material 32 in a coaxial arrangement with the mandrel system 10, defining a gap therebetween in which the material 32 is positioned. In the illustrated embodiment, the sleeve 34 incudes a plurality of radially inwardly-extending teeth 36 carried thereabout. The curing sleeve 34 is then placed under external pressure (or other suitable force), thereby driving the teeth 36 of the sleeve 34 into the material 32, and also driving the material 32 against the teeth 16, and into the grooves 18, of the mandrel surface 14. Heat and/or further pressure may be applied to form the material into the desired shape of the cylindrical belt 32.

Once sufficient heat and pressure have been applied and the belt 32 is formed into the desired shape, the curing sleeve 34 is removed and the belt 32 is slid axially off of the mandrel surface 14. The resultant drive belt 32 may be generally cylindrical, and have a set of radially inner teeth/grooves formed by the mandrel surface 14, and a set of radially outer teeth/grooves formed by the curing sleeve 32. However, is should be noted that although the description and illustrations provided herein illustrate a belt 32 with an externally-grooved surface, the belt 32 may only have inner grooves and have a smooth outer surface, or only have outer grooves and have a smooth inner surface, or have shapes other than that shown herein.

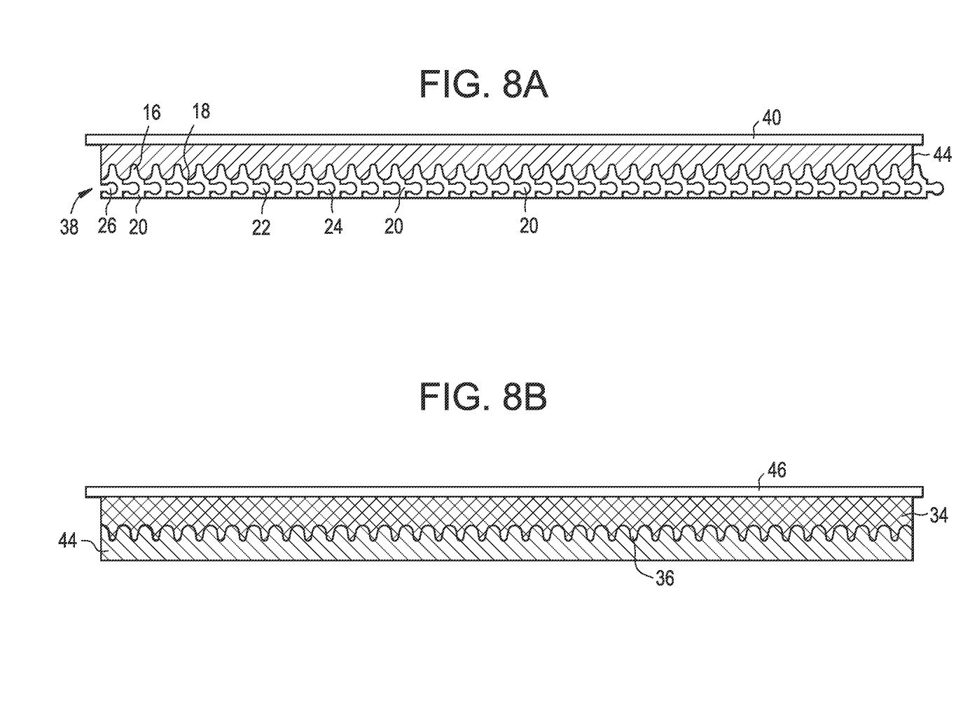

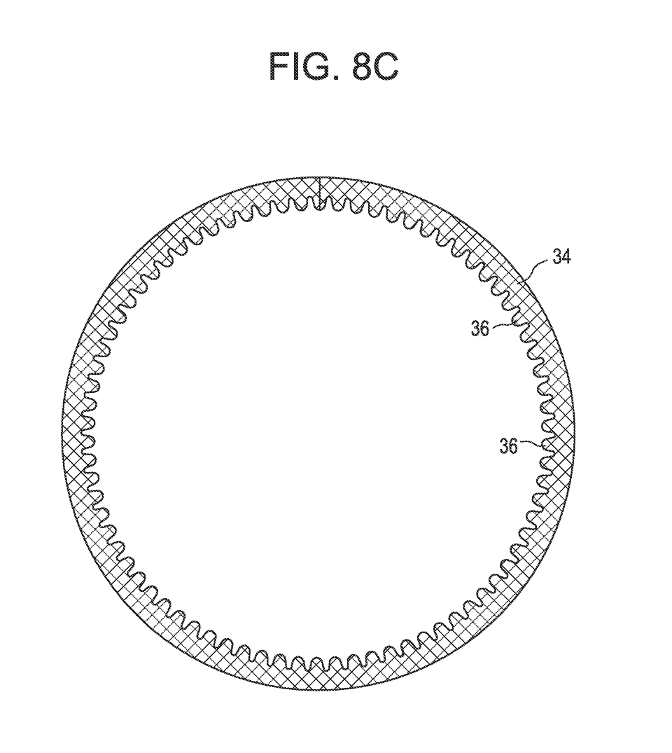

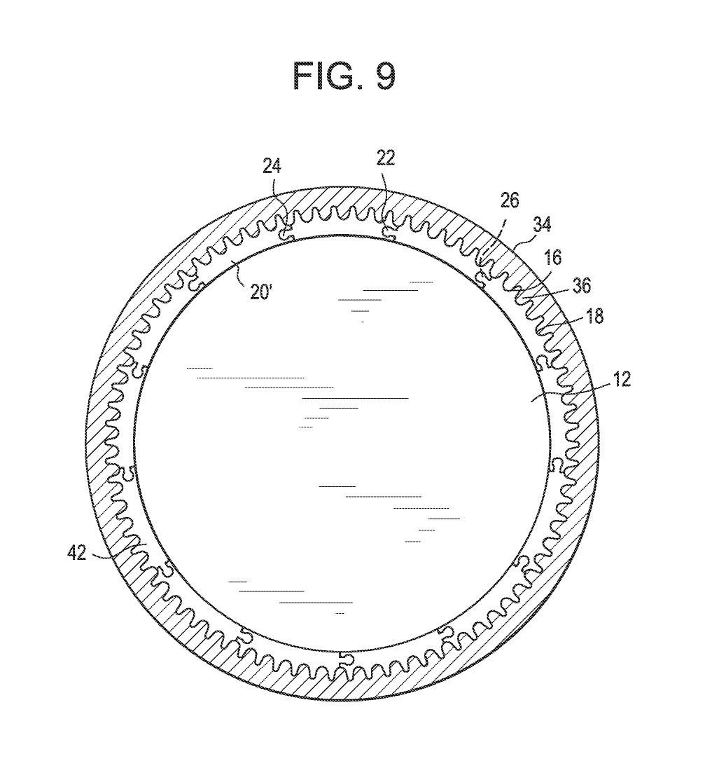

As shown in FIGS. 8A, 8B, 8C and 9, the mandrel surface 14 described and shown above, or one similar to it, may be used to form the curing jacket or sleeve 34, or a curing sleeve mold 46. In the embodiment shown in FIGS. 8A-8C, a plate/molding system 38 is provided and made up of a plurality of segments 20 (and/or segments 20′) in a similar manner to the mandrel system 10 described above. In particular, each segment 20 can have a locking portion 22/male portion 24/female portion 26, and be coupled/decoupled in the same or similar manner as the mandrel segments described above.

The plate 38 can be used to form a sleeve mold 44, which is in turn used to form the sleeve 34. In order to form the sleeve mold 44, a material used to form the sleeve mold 44, such as a very heavy gauge rubber with no cords or fabric, is then placed on the plate 38 and pressed into contact with the plate 38, such as by a press plate 40. The sleeve mold 44 is then removed from the plates 38, 40. The material used to form the sleeve 34 is then placed onto the sleeve mold 44 and pressed into contact with the sleeve mold 44, such as by a press plate 46 (FIG. 8B). The molded sleeve material 34 is then removed and formed into a closed loop shape, as shown in FIG. 8C to form the sleeve 34. The sleeve 34 can then be used to form the outer grooves in the belt 32, as shown in FIG. 7.

As shown in FIG. 9, in an alternate embodiment the sleeve 34 is formed by a mandrel system/molding component 42. In this case the sleeve 34 is formed in a cylindrical shape about the mandrel system 42 in a manner similar to the system shown in FIG. 7 for forming the belt 32, and described in the accompanying description, except that the outer surface of the sleeve 34 may be formed without any grooves/teeth formed therein. The sleeve 34 shown in FIG. 9 can then be removed from the mandrel 42 and used to form the outer grooves in the belt 32, as shown in FIG. 7.

The molding component 24 shown in FIG. 9 is made up of the segments 20′ each having multiple teeth 16, but the molding component can also be made of segments 20 with only a single tooth carried thereon, or combinations thereof. Similarly, the molding component 38 shown in FIG. 8A can be made of various types of segments 20, 20′. The molding components shown herein have teeth 16 extending radially outwardly; however, it should be understood that a molding component with teeth 16 extending radially inwardly may also be created and utilized if desired.

Thus, it can be seen that the molding components 14, 38, 42, and 50 disclosed herein can be easily manufactured and assembled. The modular shape enables the molding components 14, 38, 42 and 50 to be made from a plurality of segments 20, 20′, 52, 152, 252 etc., each of which can be an extruded shape with a relatively small cross section, which are thereby relatively easy to manufacture. The modular nature of the molding components 14, 38, 42, 50 also enables the molding components to be quickly and easily assembled in a wide variety of shapes. The system also enables easy repair and/or replacement of the segments 20, given that a segment 20 can be easily slid out of place for access and/or replacement. Finally, the system disclosed herein enables the molding components to be formed from metal, which provides better molding results, especially for the support segments 52, which have better heat transfer for shorter processing times and more uniform curing of the molded product.

Having described the invention in detail and by reference to certain embodiments, it will be apparent that modifications and variations thereof are possible without departing from the scope of the invention.

What is claimed is:

1. A mandrel for a molding system comprising:
a support structure formed in a generally closed loop shape, the support structure comprising a plurality of discrete segments coupled together; wherein the number of discrete segments is increasable or reducible to change the overall geometry of the closed loop shape.

2. The mandrel of claim 1 wherein each discrete segment of the plurality of discrete segments is permanently coupled together, or at least one discrete segment is configured to be releasably connectable with or removable from an adjacent discrete segment.

3. The mandrel of claim 1 wherein the plurality of discrete segments are slidingly couplable to one another by sliding one discrete segment generally axially relative to an adjacent component.

4. The mandrel of claim 1 wherein the support structure is generally cylindrical, has a generally circular shape in end view, and each discrete segment is generally wedge-shaped.

5. The mandrel of claim 1 wherein each discrete segment has a first connector and a second connector, the first and second connectors being the same or different; wherein each first connector of each discrete segment is releasably connectable to the second connector of an adjacent discrete segment.

6. The mandrel of claim 5 wherein each generally wedge-shaped, discrete segment has an inner edge having a radius of curvature and an outer edge having a radius of curvature.

7. The mandrel of claim 5 wherein each generally wedge shaped, discrete segment has a structural geometry having one or more elongate passages therethrough that supports the outer edge.

8. The mandrel of claim 5 wherein the first and second connectors are different, the first connector includes a female portion and the second connector includes a male portion.

9. The mandrel of claim 8 wherein the second connector further includes an overhang spaced radially outward away from the male portion such that a groove is defined therebetween, and the female portion includes an inner rail and an outer rail, the outer rail being a tongue received in the groove.

10. The mandrel of claim 5 wherein the first and second connectors are the same on an individual discrete segment, but are different from and mateable to the first and second connectors on the adjacent discrete segment.

11. The mandrel of claim 1 wherein each discrete segment is coupled with an adjacent segment by means of an independent connecting member.

12. The mandrel of claim 1 further comprising a core centered within the support structure, the core having outer surface features that maintain the alignment of the plurality of discrete segments.

13. The mandrel of claim 1 further comprising an end cap centered at the terminus of the support structure, the end plates having surface features that maintain the alignment of the plurality of discrete segments.

14. A molding system comprising:
a mandrel body having a support structure formed in a generally closed loop outer surface, the support structure comprising a plurality of discrete support segments coupled together; wherein the number of discrete support segments is increasable or reducible to change the overall geometry of the closed loop shape; and
a mandrel surface having a plurality of discrete toothed segments that form a generally closed loop shape, the mandrel surface being fit closely about the outer surface of the mandrel body with the teeth oriented radially outward away from the mandrel body.

15. The molding system of claim 14 wherein each discrete support segment has a first connector and a second connector, the first and second connectors being the same or different; wherein each first connector of each discrete support segment is releasably connectable to the second connector of an adjacent discrete support segment directly or through an independent connector.

16. The molding system of claim 14 wherein each discrete toothed segment has a first connector and a second connector, the first and second connectors being the same or different; wherein each first connector of each discrete toothed segment is releasably connectable to the second connector of an adjacent discrete toothed segment directly or through an independent connector.

17. The molding system of claim 14 wherein the support structure has a generally circular shape in end view, and each discrete support segment is generally wedge-shaped.

18. The molding system of claim 17 wherein each generally wedge shaped, discrete segment has a structural geometry having one or more elongate passages therethrough that supports the outer edge.

19. The molding system of claim 14 wherein the first and second connectors are different, wherein the first connector includes a female portion having an inner rail and an outer rail, and the second connector includes a male portion and an overhang spaced radially outward away from the male portion such that a groove is defined therebetween, wherein the outer rail of the female portion is a tongue received in the groove defined by the male portion.

20. The molding system of claim 14 wherein each discrete toothed segment includes one or more teeth that extends generally radially outwardly relative to the mandrel body.

21. The molding system of claim 14 further comprising a supplemental component formed in a generally closed loop shape and having a plurality of radially extending teeth, wherein the teeth of the supplemental component extend in the opposite direction to the teeth of the mandrel surface, and wherein the mandrel surface and the supplemental component are generally concentric and define a gap therebetween.
